(19) United States
(12) Patent Application Publication
(10) Pub. No.: US 2016/0193999 A1
(43) Pub. Date: Jul. 7, 2016

(54) VEHICLE TRAVEL SAFETY DEVICE, VEHICLE TRAVEL SAFETY METHOD, AND VEHICLE TRAVEL SAFETY PROGRAM

(71) Applicant: HONDA MOTOR CO., LTD., Tokyo (JP)

(72) Inventor: Yoji SASABUCHI, SHIOYA-GUN (JP)

(21) Appl. No.: 14/905,020

(22) PCT Filed: Jul. 19, 2013
(86) PCT No.: PCT/JP2013/069639

§ 371 Date: Jan. 14, 2016

(51) Int. Cl. B60W 30/08; G08G 1/16

(52) U.S. Cl. CPC B60W 30/08; G08G 1/165; G08G 1/166

(57) ABSTRACT

Disclosed is a vehicle travel safety device including: an object information detection unit that detects information regarding an object; a vehicle status information detection unit that detects information regarding the status of a vehicle; a collision probability determination unit that determines whether or not the vehicle may collide with the object, regarding which information is detected by the object information detection unit; and a collision avoidance assistance unit that performs collision avoidance assistance when the collision probability determination unit determines that the vehicle may collide with the object, and restricts collision avoidance assistance according to the status of steering performed by a driver of the vehicle.

### TECHNICAL FIELD

The present invention relates to a vehicle travel safety device, a vehicle travel safety method, and a vehicle travel safety program.

### BACKGROUND ART

A technology, which allows a radar unit and a camera to detect (sense) an object, and changes a brake application timing or an alarm timing according to a detection situation, is present in a vehicle travel safety device (refer to PTL 1).

### CITATION LIST

### Patent Literature

[PTL 1] Japanese Unexamined Patent Application, First Publication No. 2007-91207

### SUMMARY OF INVENTION

### Technical Problem

The vehicle travel safety device has a problem in that if an object is detected when the driver of a vehicle intends to move the vehicle toward the object, the brakes are applied or an alarm operates at the same timing as in other cases, which annoys the driver.

As a specific example, when there is an obstacle such as a right-turning vehicle in front of the vehicle, and a host vehicle is expected to move toward the vicinity of a sidewalk or an intersection shortly after avoiding the obstacle using a steering device, the vehicle travel safety device may perform an excessive operation in response to a pedestrian or a roadside structure on the sidewalk or at the intersection at a normal control timing.

FIG. 19 is a view illustrating an example of normal collision avoidance assistance.

A vehicle (host vehicle) 2001 with a vehicle travel safety device is traveling on a road 2011. On the road 2011, there is a crosswalk 2012 before an intersection, a crosswalk 2013 after the intersection, and a roadside structure (for example, a pole) 2014 in the vicinity of the crosswalk 2013 after the intersection, and on the right side relative to a forward moving direction of the vehicle 2001. A road runs through the intersection and perpendicular to the forward moving direction of the vehicle 2001, and there is another vehicle 2002 on the road and on the left side relative to the forward moving direction of the vehicle 2001, waiting to turn right. There is a person 2003, who is a pedestrian, in the vicinity of the roadside structure 2014.

In this situation, the driver of the vehicle 2001 avoids the other vehicle 2002 by turning the vehicle 2001 to the right, and thereafter, the driver turns the vehicle 2001 to the left such that the vehicle 2001 returns to the host vehicle lane. When the vehicle travel safety device detects that there is an obstacle object (the roadside structure 2014 or the person 2003) in front of a vehicle 2001a (the vehicle 2001 which has moved), the vehicle travel safety device operates the control of an alarm or the like for the obstacle in front of the vehicle. In this case, since the driver of the vehicle 2001 intentionally turns the vehicle 2001, when an operation is performed at a normal operation timing, the driver may deem the operation as being excessive.

The present invention is made to solve such a problem, and an object of the present invention is to provide a vehicle travel safety device, a vehicle travel safety method, and a vehicle travel safety program which are capable of adjusting one or both of the operation timing or the release timing of collision avoidance assistance (for example, the control of brakes or an alarm) compared to other cases when it is determined (estimated) that a driver of a vehicle intentionally moves the vehicle toward an object, and the object is detected.

### Solution to Problem

(1) In order to solve this problem, according to an aspect of the present invention, there is provided a vehicle travel safety device (for example, a vehicle travel safety device 1 in an embodiment) including: an object information detection unit (for example, an external field sensor 12, an object detection unit 21, and a vehicle interior sensor 13 in the embodiment) that detects information regarding an object; a vehicle status information detection unit (for example, a vehicle status detection unit 14 in the embodiment) that detects information regarding the status of a vehicle; a collision probability determination unit (for example, a collision probability determination unit 22 in the embodiment) that determines whether or not the vehicle may collide with the object, regarding which information is detected by the object information detection unit; and a collision avoidance assistance unit (for example, a collision avoidance assistance unit 23 in the embodiment) that performs collision avoidance assistance when the collision probability determination unit determines that the vehicle may collide with the object, and restricts collision avoidance assistance according to the status of steering performed by a driver of the vehicle. Accordingly, it is possible to restrict excessive collision avoidance assistance when the driver intentionally turns the vehicle.

(2) According to the aspect of the present invention, in the vehicle travel safety device disclosed in (1), the collision avoidance assistance unit may restrict collision avoidance assistance when there is an object in a steering direction depending on the status of steering performed by the driver of the vehicle. Accordingly, it is possible to restrict excessive collision avoidance assistance when the driver intentionally turns the vehicle, and there is an object in the steering direction.

(3) According to the aspect of the present invention, in the vehicle travel safety device disclosed in (1) or (2), the collision avoidance assistance unit may restrict collision avoidance assistance when the driver intentionally turns the vehicle in a state where an object is detected in front of the vehicle. Accordingly, when the driver avoids the object in front of the vehicle (which may include positions offset in rightward and leftward directions), collision avoidance assistance is restricted, it is possible to accurately recognize the steering operation as a driver's intention, and to restrict collision avoidance assistance.

(4) According to the aspect of the present invention, in the vehicle travel safety device disclosed in any one of (1) to (3), the collision avoidance assistance unit may determine whether an object in the steering direction is a person or an object other than a person, and if it is determined that the object is a person, the collision avoidance assistance unit may reduce the amount of restriction to collision avoidance assistance compared to when it is determined that the object is an object other than a person. Accordingly, it is possible to restrict collision avoidance assistance such that a person (for example, a pedestrian) is prevented from being frightened.

(5) According to the aspect of the present invention, in the vehicle travel safety device disclosed in any one of (1) to (4), the collision avoidance assistance unit may reduce the amount of restriction to collision avoidance assistance to the extent that the amount of overlap between an object in the steering direction and the vehicle is large. Accordingly, it is possible to change the amount of restriction to collision avoidance assistance according to the amount of overlap between the object in the steering direction and the vehicle (host vehicle), and thus, it is possible to appropriately execute collision avoidance assistance while restricting excessive collision avoidance assistance.

(6) According to the aspect of the present invention, in the vehicle travel safety device disclosed in any one of (1) to (5), the collision avoidance assistance unit may restrict collision avoidance assistance when the driver turns the vehicle in a state where it is determined that there is an intersection. Accordingly, it is possible to recognize that the tip of a crossing vehicle passes over a lane (lane of the vehicle) at the intersection, or that the driver intends to turn the vehicle (host vehicle) right or left, and to restrict excessive collision avoidance assistance.

(7) According to the aspect of the present invention, in the vehicle travel safety device disclosed in (6), when the collision avoidance assistance unit detects any one of a crossing vehicle in front of the vehicle, right turn or left turn of a proceeding vehicle, a traffic signal, a crosswalk, and a roadside structure which is disposed such that two sides intersect each other, the collision avoidance assistance unit may determine that there is an intersection. Accordingly, it is possible to accurately recognize the intersection.

(8) In order to solve this problem, according to another aspect of the present invention, there is provided a vehicle travel safety method including: detecting information regarding an object using an object information detection unit; detecting information regarding the status of a vehicle using a vehicle status information detection unit; determining whether or not the vehicle may collide with the object, regarding which information is detected by the object information detection unit, using a collision probability determination unit; and performing collision avoidance assistance when the collision probability determination unit determines that the vehicle may collide with the object, and restricting collision avoidance assistance according to the status of steering performed by a driver of the vehicle, using a collision probability determination unit. Accordingly, it is possible to restrict excessive collision avoidance assistance when the driver intentionally turns the vehicle.

(9) In order to solve this problem, according to still another aspect of the present invention, there is provided a vehicle travel safety program causing a computer to execute: a step of detecting information regarding an object using an object information detection unit; a step of detecting information regarding the status of a vehicle using a vehicle status information detection unit; a step of determining whether or not the vehicle may collide with the object, regarding which information is detected by the object information detection unit, using a collision probability determination unit; and a step of performing collision avoidance assistance when the collision probability determination unit determines that the vehicle may collide with the object, and restricting collision avoidance assistance according to the status of steering performed by a driver of the vehicle, using a collision probability determination unit. Accordingly, it is possible to restrict excessive collision avoidance assistance when the driver intentionally turns the vehicle.

### Advantageous Effects of Invention

(1) According to the aspect of the present invention, the vehicle travel safety device performs collision avoidance assistance when it is determined that the vehicle may collide with an object, and restricts collision avoidance assistance according to the status of steering performed by the driver of the vehicle. Therefore, it is possible to restrict excessive collision avoidance assistance when the driver intentionally turns the vehicle.

(2) According to the aspect of the present invention, the vehicle travel safety device restricts collision avoidance assistance when there is an object in a steering direction depending on the status of steering performed by the driver of the vehicle. Therefore, it is possible to restrict excessive collision avoidance assistance when the driver intentionally turns the vehicle, and there is an object in the steering direction.

(3) According to the aspect of the present invention, the vehicle travel safety device restricts collision avoidance assistance when the driver intentionally turns the vehicle in a state where an object is detected in front of the vehicle. Therefore, when the driver avoids the object in front of the vehicle (which may include positions offset in the rightward and leftward directions), collision avoidance assistance is restricted, it is possible to accurately recognize the steering operation as a driver's intention, and to restrict excessive collision avoidance assistance.

(4) According to the aspect of the present invention, the vehicle travel safety device determines whether an object in the steering direction is a person or an object other than a person. When it is determined that the object is a person, the vehicle travel safety device reduces the amount of restriction to collision avoidance assistance compared to when it is determined that the object is the object other than a person. Therefore, it is possible to restrict excessive collision avoidance assistance such that the person (for example, a pedestrian) is prevented from being frightened.

(5) According to the aspect of the present invention, the vehicle travel safety device is capable of changing the amount of restriction to collision avoidance assistance according to the amount of overlap between the object in the steering direction and the vehicle (host vehicle) by reducing the amount of restriction to collision avoidance assistance to the extent that the amount of overlap between an object in the steering direction and the vehicle is large. Therefore, it is possible to appropriately execute collision avoidance assistance while restricting excessive collision avoidance assistance.

(6) According to the aspect of the present invention, the vehicle travel safety device restricts collision avoidance assistance when the driver turns the vehicle in a state where it is determined that there is an intersection. Therefore, it is possible to recognize that the tip of a crossing vehicle passes over a lane (lane of the vehicle) at the intersection, or that the driver intends to turn the vehicle (host vehicle) right or left, and to restrict excessive collision avoidance assistance.

(7) According to the aspect of the present invention, when the vehicle travel safety device detects any one of a crossing vehicle in front of the vehicle, right turn or left turn of a proceeding vehicle, a traffic signal, a crosswalk, and a roadside structure which is disposed such that two sides intersect each other, the vehicle travel safety device determines that there is an intersection. Therefore, it is possible to accurately recognize the intersection.

(8) According to the vehicle travel safety method in the other aspect of the present invention, collision avoidance assistance is performed when it is determined that the vehicle may collide with an object, and collision avoidance assistance is restricted according to the status of steering performed by the driver of the vehicle. Therefore, it is possible to restrict excessive collision avoidance assistance when the driver intentionally turns the vehicle.

(9) According to the vehicle travel safety program in still other aspect of the present invention, collision avoidance assistance is performed when it is determined that the vehicle may collide with an object, and collision avoidance assistance is restricted according to the status of steering performed by the driver of the vehicle. Therefore, it is possible to restrict excessive collision avoidance assistance when the driver intentionally turns the vehicle.

### BRIEF DESCRIPTION OF DRAWINGS

FIG. 1 is a block diagram illustrating the schematic configuration of a vehicle travel safety device in an embodiment of the present invention.

FIG. 2 is a view illustrating an example of a situation in which timing adjustment for collision avoidance assistance is executed in the embodiment of the present invention.

FIG. 3 is a view illustrating an example of a situation in which timing adjustment for collision avoidance assistance is executed in the embodiment of the present invention.

FIG. 4 is a view illustrating an example of a situation in which timing adjustment for collision avoidance assistance is executed in the embodiment of the present invention.

FIG. 5 is a view illustrating an example of a situation in which timing adjustment for collision avoidance assistance is executed in the embodiment of the present invention.

FIG. 6 is a view illustrating an example of a technique of determining whether or not there is an object which has to be avoided by a vehicle in the embodiment of the present invention.

FIG. 7 is a view illustrating an example of a technique of determining whether or not there is an object which has to be avoided by a vehicle in the embodiment of the present invention.

FIG. 8 is a view illustrating an example of a technique of determining whether or not there is an intersection in the embodiment of the present invention.

FIG. 9 is a view illustrating an example of a technique of determining whether or not there is an intersection in the embodiment of the present invention.

FIG. 10 is a graph illustrating an example of timing adjustment for collision avoidance assistance in the embodiment of the present invention.

FIG. 11 is a graph illustrating another example of timing adjustment for collision avoidance assistance in the embodiment of the present invention.

FIG. 12 is a view illustrating the amount of overlap in the embodiment of the present invention.

FIG. 13 is a graph illustrating an example of timing adjustment for collision avoidance assistance in the embodiment of the present invention.

FIG. 14 is a graph illustrating another example of timing adjustment for collision avoidance assistance in the embodiment of the present invention.

FIG. 15 is a flowchart illustrating an example of the flow of timing adjustment for collision avoidance assistance in a first embodiment of the present invention.

FIG. 16 is a flowchart illustrating an example of the flow of timing adjustment for collision avoidance assistance in a second embodiment of the present invention.

FIG. 17 is a flowchart illustrating an example of the flow of timing adjustment for collision avoidance assistance in a third embodiment of the present invention.

FIG. 18 is a flowchart illustrating an example of the flow of timing adjustment for collision avoidance assistance in a fourth embodiment of the present invention.

FIG. 19 is a view illustrating an example of normal collision avoidance assistance.

### DESCRIPTION OF EMBODIMENTS

Hereinafter, an embodiment of the present invention will be described with reference to the accompanying drawings. The embodiment of the present invention is merely a specific description of the invention defined in the claims disclosed herein and equivalents thereto, and based on the content of this disclosure, it will become apparent to persons skilled in the art that the embodiment is not intended to limit the present invention.

[Outline of Vehicle Travel Safety Device in Embodiment]

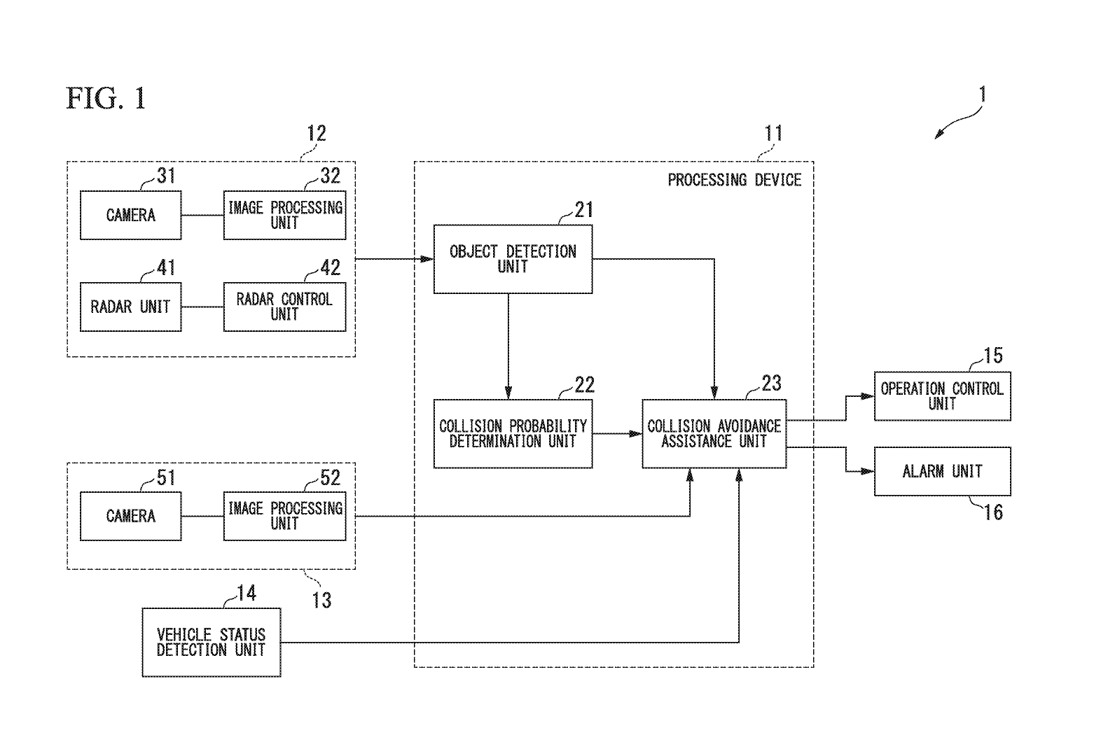

FIG. 1 is a block diagram illustrating the schematic configuration of a vehicle travel safety device 1 in an embodiment of the present invention.

The vehicle travel safety device 1 in the embodiment includes a processing device 11; an external field sensor 12; a vehicle interior sensor 13; a vehicle status detection unit 14; an operation control unit 15; and an alarm unit 16.

The processing device 11 includes an object detection unit 21; a collision probability determination unit 22; and a collision avoidance assistance unit 23.

The external field sensor 12 includes a camera 31; an image processing unit 32; a radar unit 41; and a radar control unit 42.

The vehicle interior sensor 13 includes a camera 51 and an image processing unit 52.

The travel safety device 1 in the embodiment is provided in a vehicle.

The external field sensor 12 is a sensor that detects information regarding an external field relative to a vehicle.

The camera 31 is provided to be capable of capturing an image of the external field of the vehicle (for example, a region in front of the vehicle), and outputs captured image information to the image processing unit 32.

The image processing unit 32 performs a predetermined process on the image information input from the camera 31, and outputs the processed image information to the object detection unit 21. The predetermined process may include various processes such as a filtering process and a binarization process.

The radar unit 41 is provided to be capable of emitting (transmitting) an electromagnetic wave (for example, millimeter wave) to the external field of the vehicle (for example, a region in front of the vehicle), and receives a fraction of the emitted electromagnetic wave which returns to the radar unit 41 after being reflected by an object.

The radar control unit 42 controls the operation of the radar unit 41, and outputs information (radar information) regarding the electromagnetic waves emitted from and received by the radar unit 41 to the object detection unit 21.

The vehicle interior sensor 13 is a sensor that detects information regarding a vehicle interior (the interior of the vehicle).

The camera 51 is provided to be capable of capturing an image of the vehicle interior (for example, a driver), and outputs captured image information to the image processing unit 52.

The image processing unit 52 performs a predetermined process on the image information input from the camera 51, and outputs the processed image information to the collision avoidance assistance unit 23. The predetermined process may include various processes such as a filtering process and a binarization process.

The vehicle status detection unit 14 detects predetermined information regarding the status of the vehicle (host vehicle), and outputs the detected information (a vehicle status information) to the collision avoidance assistance unit 23. The vehicle status information may include various pieces of information: information regarding a steering angle (the direction or the magnitude of a steering angle input by a driver); information regarding an actual steering angle (turning angle) corresponding to a steering angle; information regarding a yaw angle (the rotational angle of a vehicle's center of gravity around a vertical axis); information regarding a yaw rate (the rotational angular velocity of the vehicle's center of gravity around the vertical axis); information regarding the speed of the vehicle (vehicle speed); information regarding the acceleration of the vehicle; information regarding the position or the forward moving direction of the vehicle based on a global positioning system (GPS) and the like; and the like.

The object detection unit 21 receives the image information from the image processing unit 32 of the external field sensor 12, and the radar information from the radar control unit 42 of the external field sensor 12, detects information regarding an object in the external field of the vehicle, based on one or both of the pieces of information, and outputs the detected information (object information) to the collision probability determination unit 22 and the collision avoidance assistance unit 23. The object information may include various pieces of information: information indicating that an object is present; information indicating that the object present accords with a predetermined template (for example, a vehicle template); information regarding the position of the object present; information regarding the distance to the object present (for example, a relative distance between the object and the host vehicle); information regarding the speed of the object present; information regarding a movement direction of the object present; and the like.

As an example, the object detection unit 21 detects the object information, based on the image information input from the image processing unit 32 of the external field sensor 12, and the radar information input from the radar control unit 42 of the external field sensor 12.

As a specific example, the object detection unit 21 detects the distance to, the movement speed, and the like of an obstacle (object) using an electromagnetic wave from the radar unit 41, and performs an object recognition process for the obstacle (object) based on the image information from the camera 31. As a result, when the position of the object (the target of the object) detected using the electromagnetic wave from the radar unit 41 and the position of the object recognized based on the image information from the camera 31 are within a predetermined range, and both positions are capable of matching each other, the object detection unit 21 adds the object information recognized based on the image information from the camera 31 to the object information detected using the electromagnetic wave from the radar unit 41, and outputs information from the addition process to the collision probability determination unit 22 as the object information.

As such, when the image information from the camera 31 is fused with the radar information from the radar unit 41, for example, even if the image information from the camera 31 does not sufficiently provide the accuracy of the distance to an object, it is possible to sufficiently ensure the accuracy of the distance to the object by using the radar information from the radar unit 41. For example, even if the radar information from the radar unit 41 does not sufficiently provide the accuracy of the recognition (determination) of an object, it is possible to sufficiently ensure the accuracy of the recognition (determination) of the object by using the image information from the camera 31.

Typically, the radar information from the radar unit 41 provides good depth (for example, the distance to an object) detection accuracy, and the image information from the camera 31 provides good accuracy of the detection of information regarding an object in a lateral direction (for example, the position or the width of the object in the lateral direction), or good accuracy of the recognition of the object.

As another configuration example, the object detection unit 21 may receive image information from the image processing unit 32 of the external field sensor 12, and based on this information, detect information regarding an object in the external field of the vehicle. In this case, for example, the external field sensor 12 may not include the radar unit 41 and the radar control unit 42.

As another configuration example, the object detection unit 21 may receive radar information from the radar control unit 42 of the external field sensor 12, and based on this information, detect information regarding an object in the external field of the vehicle. In this case, for example, the external field sensor 12 may not include the camera 31 and the radar control unit 42.

The collision probability determination unit 22 receives information regarding an object in the external field from the object detection unit 21, determines a probability for collision between the host vehicle and other objects based on the input object information, and outputs information regarding a determination result (determination result information) to the collision avoidance assistance unit 23. The determination result information may be information indicating whether or not there is a probability of collision between the host vehicle and other objects, or may be a combination of the information indicating whether or not there is a possibility of collision between the host vehicle and other objects, and one or more pieces of information such as information regarding the degree of a probability of collision, information regarding the other objects which are collision objects, and information regarding a situation in the vicinity of the host vehicle.

The collision avoidance assistance unit 23 receives the object information from the object detection unit 21, the determination result information from the collision probability determination unit 22, image information regarding an object in the vehicle interior from the image processing unit 52 of the vehicle interior sensor 13, and the vehicle status information from the vehicle status detection unit 14, generates and outputs a signal (operation control signal) to control the operation of the vehicle (host vehicle) to the operation control unit 15, and generates and outputs a signal (alarm control signal) to control an alarm to the alarm unit 16, based on all or parts of the pieces of information.

The operation control unit 15 receives the operation control signal from the collision avoidance assistance unit 23, and based on the input operation control signal, (automatically) controls the operation of the vehicle (host vehicle). The control of the operation of the vehicle may include various forms of operation control such as brake control (for example, the application of brakes) and steering control.

The alarm unit 16 receives the alarm control signal from the collision avoidance assistance unit 23, and (automatically) gives the alarm based on the input alarm control signal.

[Details of Collision Avoidance Assistance in Embodiment]

<Example of Situation in which Timing Adjustment for Collision Avoidance Assistance is Executed in Embodiment>

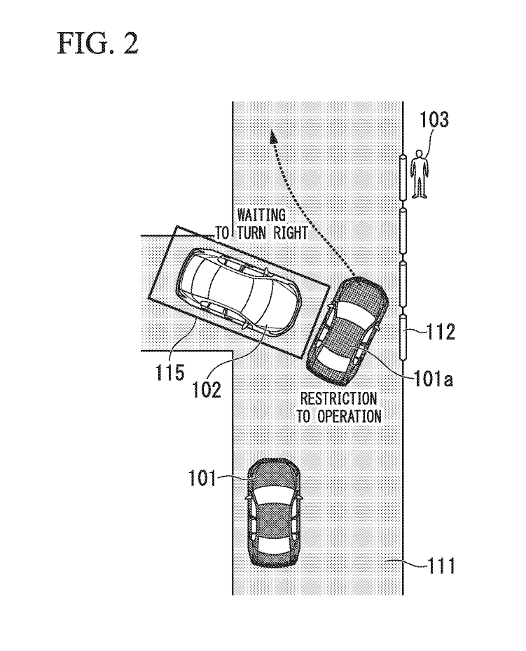

An example of a situation in which timing adjustment for collision avoidance assistance is executed in the embodiment will be described with reference to FIGS. 2 to 5.

FIG. 2 is a view illustrating an example of a situation in which timing adjustment for collision avoidance assistance is executed in the embodiment.

A vehicle (host vehicle) 101 with the travel safety device 1 is traveling on a road 111. On the road 111, there is a roadside structure 112 (for example, a guardrail) on the right side relative to a forward moving direction of the vehicle 101. There is a road on the left side relative to the forward moving direction of the vehicle 101, and there is another vehicle 102 on the road, waiting to turn right. There is a person 103, who is a pedestrian, in the vicinity of the roadside structure 112. FIG. 2 illustrates a frame 115 which represents the image portion of the other vehicle 102 that is captured by the object detection unit 21 of the travel safety device 1 through image processing.

In this situation, the driver of the vehicle 101 avoids the other vehicle 102 by turning the vehicle 101 to the right, and thereafter, turns the vehicle 101 to the left such that the vehicle 101 returns to a host vehicle lane. When the travel safety device 1 detects that there is an obstacle object (the roadside structure 112 or the person 103) in front of a vehicle 101a (the vehicle 101 which has moved), the travel safety device 1 operates the control of a brake, an alarm, or the like for the obstacle in front of the vehicle 101a. In this case, since the drive of the vehicle 101 intentionally turns the vehicle 101, when an operation is performed at a normal operation timing, the driver deems the operation as being excessive. For this reason, the collision avoidance assistance unit 23 of the travel safety device 1 executes timing adjustment for collision avoidance assistance so as to reduce a feeling of excessiveness.

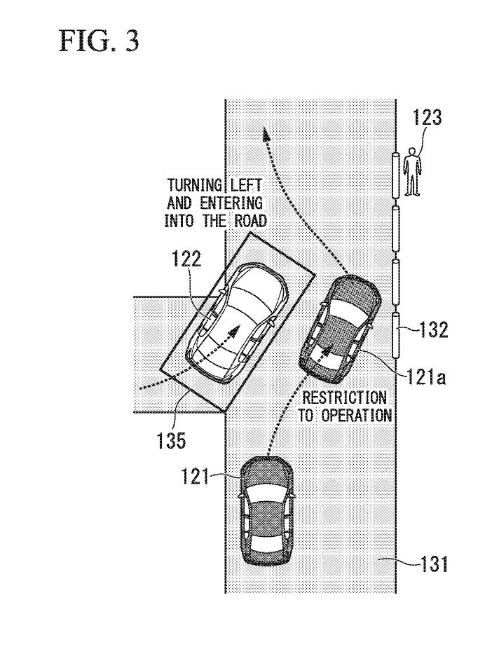

FIG. 3 is a view illustrating an example of a situation in which timing adjustment for collision avoidance assistance is executed in the embodiment.

In the example illustrated in FIG. 3, a road 131 on which a vehicle (host vehicle) 121 with the travel safety device 1 is traveling, a roadside structure 132, and a person 123 are situated in the same manner as the example illustrated in FIG. 2. The example illustrated in FIG. 3 is different from the example illustrated in FIG. 2 in that another vehicle 122 waits to turn left and enter into the road 131. FIG. 3 illustrates a frame 135 of the image portion of the other vehicle 122. Also in this situation, when the travel safety device 1 detects that there is an obstacle object (the roadside structure 132 or the person 123) in front of a vehicle 121a (the vehicle 121 which has moved), the travel safety device 1 executes timing adjustment for collision avoidance assistance.

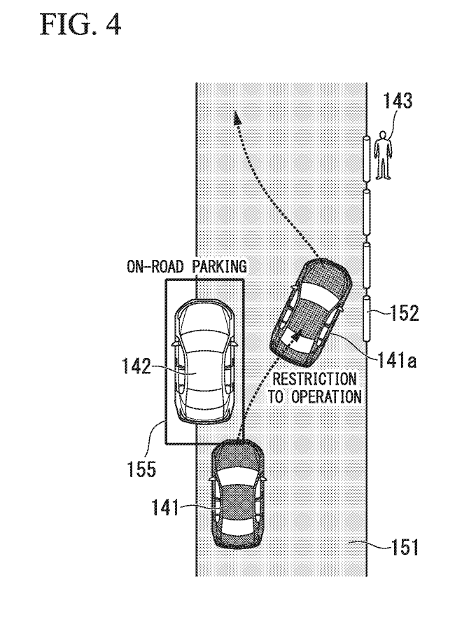

FIG. 4 is a view illustrating an example of a situation in which timing adjustment for collision avoidance assistance is executed in the embodiment.

In the example illustrated in FIG. 4, a road 151 on which a vehicle (host vehicle) 141 with the travel safety device 1 is traveling, a roadside structure 152, and a person 143 are situated in the same manner as the example illustrated in FIG. 2. The example illustrated in FIG. 4 is different from the example illustrated in FIG. 2 in that a road is not on the left side relative to a forward moving direction of the vehicle 141. The example illustrated in FIG. 4 is different from the example illustrated in FIG. 2 in that another vehicle 142 is parked at the left end of the road 151 relative to the forward moving direction of the vehicle 141. FIG. 4 illustrates a frame 155 of the image portion of the other vehicle 142. Also in this situation, when the travel safety device 1 detects that there is an obstacle object (the roadside structure 152 or the person 143) in front of a vehicle 141a (the vehicle 141 which has moved), the travel safety device 1 executes timing adjustment for collision avoidance assistance.

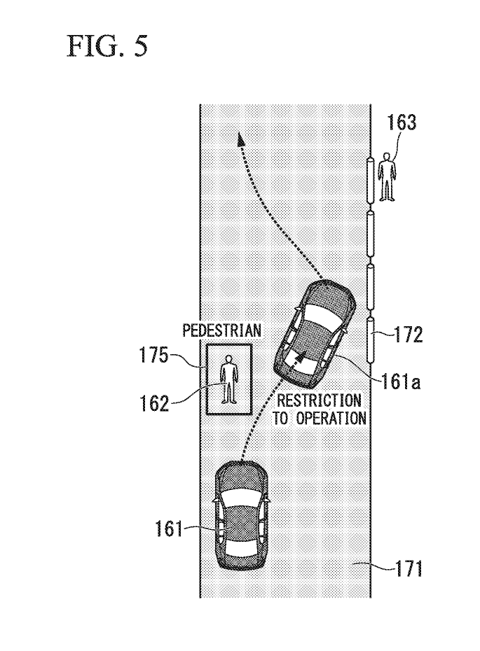

FIG. 5 is a view illustrating an example of a situation in which timing adjustment for collision avoidance assistance is executed in the embodiment.

In the example illustrated in FIG. 5, a road 171 on which a vehicle (host vehicle) 161 with the travel safety device 1 is traveling, a roadside structure 172, and a person 163 are situated in the same manner as the example illustrated in FIG. 4. The example illustrated in FIG. 5 is different from the example illustrated in FIG. 4 in that the vehicle 142 is not present, and there is the person 162, who is a pedestrian, at the left end of the road 171 relative to a forward moving direction of the vehicle 161. FIG. 5 illustrates a frame 175 of the image portion of the person 162. Also in this situation, when the travel safety device 1 detects that there is an obstacle object (the roadside structure 172 or the person 163) in front of a vehicle 161a (the vehicle 161 which has moved), the travel safety device 1 executes timing adjustment for collision avoidance assistance.

In the examples illustrated in FIGS. 2 to 5, the vehicle (host vehicle) avoids an obstacle object that is in the host vehicle lane or in the vicinity thereof. The obstacle may be various objects, or can be a traversing vehicle, a proceeding vehicle, a two-wheeled vehicle, a bicycle, a pedestrian, and the like.

<Example of Conditions for Executing Timing Adjustment for Collision Avoidance Assistance in Embodiment>

When it is determined that a predetermined condition or two or more predetermined conditions are satisfied, the collision avoidance assistance unit 23 executes timing adjustment for collision avoidance assistance.

The conditions for executing timing adjustment for collision avoidance assistance may include various conditions, and (examples of conditions) are described hereinafter.

### Example 1 of Condition

A situation in which a vehicle (host vehicle) is not moving straight ahead can be used as a condition.

When this condition is used, the condition can be satisfied only when the vehicle is not moving straight ahead. Conversely, the condition cannot be satisfied when the vehicle is moving straight ahead.

### Example 2 of Condition

A situation in which the driver of a vehicle (host vehicle) moves the vehicle toward an object by intentionally turning the vehicle (for example, an object avoidance action through a steering operation) can be used as a condition. In other words, this condition corresponds to a condition under which an object in front of the vehicle (which may include positions offset in rightward and leftward directions) is being avoided.

When this condition is used, the condition can be satisfied only when the driver intentionally turns the vehicle. Conversely, the condition cannot be satisfied when the vehicle is turned, which is unintended by the driver.

### Example 3 of Condition

A situation in which there is an intersection at the position of or in front of a vehicle (host vehicle) can be used as a condition.

When this condition is used, the condition can be satisfied only when there is the intersection at the position of or in front of the vehicle. Conversely, the condition cannot be satisfied when there is no intersection at the position or in front of the vehicle.

### Example 4 of Condition

A situation in which a predetermined object is deemed as an obstacle to a vehicle (host vehicle) can be used as a condition. The predetermined object can be another object or the like other than a person.

When this condition is used, the condition can be satisfied only when the predetermined object is deemed as an obstacle to the vehicle. Conversely, the condition cannot be satisfied when the predetermined object is not deemed as an obstacle to the vehicle.

### Example 5 of Condition

A situation in which timing adjustment for collision avoidance assistance is executed due to a driver's instruction can be used as a condition.

When this condition is used, the condition can be satisfied only when timing adjustment for collision avoidance assistance is executed due to a driver's instruction. Conversely, the condition cannot be satisfied when the execution of timing adjustment for collision avoidance assistance is not instructed by a driver.

<Specific Technique Related to Examples of Conditions for Executing Timing Adjustment for Collision Avoidance Assistance in Embodiment>

Hereinafter, specific techniques related to the aforementioned examples of conditions will be described.

(Specific Technique for Example 1 of Condition)

As an example, with regard to the condition under which the vehicle (host vehicle) is not moving straight ahead, the collision avoidance assistance unit 23 is capable of determining whether or not the vehicle is moving straight ahead by determining whether or not the orientation of a steering wheel indicates a straight-ahead position based on steering information included in vehicle status information input from the vehicle status detection unit 14.

As another example, the collision avoidance assistance unit 23 is capable of determining whether or not the vehicle is moving straight ahead based on information regarding a forward moving direction of the vehicle which is contained in the vehicle status information input from the vehicle status detection unit 14.

As another example, the collision avoidance assistance unit 23 determines whether or not the face or the eyes (the sight) of the driver in an image move (laterally rotate relative to the forward moving direction) either to the right or to the left relative to the forward moving direction at a predetermined angle or greater based on image information input from the image processing unit 52 of the vehicle interior sensor 13. When it is determined that the face or the eyes move as described above, the collision avoidance assistance unit 23 is capable of (presumptively) determining that the vehicle is not moving straight ahead. As another example, when based on the image information input from the image processing unit 52 of the vehicle interior sensor 13, it is determined that the movement of the face or the eyes (the sight) of the driver in an image to either the right or the left relative to the forward moving direction at a predetermined angle or greater is maintained for a predetermined amount of time or longer, the collision avoidance assistance unit 23 is capable of (presumptively) determining that the vehicle is not moving straight ahead.

This determination may be performed based on other pieces of information.

This determination may be performed by another processing unit (for example, the collision probability determination unit 22) other than the collision avoidance assistance unit 23, and determination result information may be input to and used by the collision avoidance assistance unit 23.

(Specific Technique for Example 2 of Condition)

As an example, with regard to the condition under which the driver of a vehicle (host vehicle) moves the vehicle toward an object by intentionally turning the vehicle, the collision avoidance assistance unit 23 is capable of determining whether or not the driver of the vehicle intentionally turn the vehicle (whether or not a steering operation is performed by the driver) based on steering information input from the vehicle status detection unit 14.

As another example, the collision avoidance assistance unit 23 is capable of determining whether or not the vehicle moves toward an object (whether or not there is an obstacle object in a movement direction of the vehicle) based on object information input from the object detection unit 21.

As another example, the collision avoidance assistance unit 23 determines whether or not there is an object which has to be avoided by the vehicle based on the object information input from the object detection unit 21, and when there is an object which has to be avoided by the vehicle, the collision avoidance assistance unit 23 is capable of determining that the driver of the vehicle intentionally turns the vehicle.

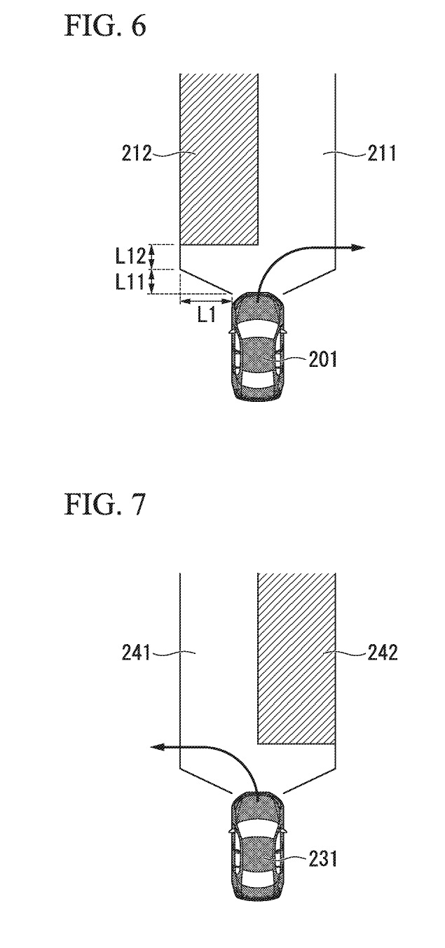

This determination will be described with reference to FIGS. 6 and 7.

FIG. 6 is a view illustrating an example of a technique of determining whether or not there is an object which has to be avoided by a vehicle in the embodiment.

According to the technique in this example, when a vehicle (host vehicle) 201 with the travel safety device 1 is turned right, and it is determined that there is an obstacle object in a predetermined region (detection target region) 212 on a front left side, it is determined that there is an object which has to be avoided by the vehicle 201.

FIG. 6 illustrates a region 211 as a reference which is surrounded by lines connecting both end points of the lateral width of a front portion of the vehicle 201 to points that are positioned in front of both ends of line segments by a length of L11 in a direction perpendicular to the line segments that extend a length of L1 rightwards and leftwards from the lateral width of the front portion of the vehicle 201, and lines which extend forwards from the points in the direction perpendicular to the line segments. The detection target region 212 is a portion (hatched region in the example illustrated in FIG. 6) of a left half region of the region 211 relative to a forward moving direction of the vehicle 201, with the portion being separated from the front portion of the vehicle 201 by a distance (distance in the perpendicular direction) of (L11+L12) or greater.

The detection target region 212 is set, and thus, when there is an obstacle object in the detection target region 212, it is determined that there is an object which has to be avoided by the vehicle 201, and the driver of the vehicle 201 intentionally turns the vehicle 201 right (the vehicle 201 is turned left to return to its original direction after being turned right to avoid the object, or a steering operation for turning the vehicle 201 right).

FIG. 7 is a view illustrating an example of a technique of determining whether or not there is an object which has to be avoided by a vehicle in the embodiment.

According to the technique in this example, when a vehicle (host vehicle) 231 with the travel safety device 1 is turned left, and it is determined that there is an obstacle object in a predetermined region (detection target region) 242 on a front right side, it is determined that there is an object which has to be avoided by the vehicle 231.

In the example in FIG. 7, right and left sides are reversed compared to the example illustrated in FIG. 6 (bilaterally symmetrical). The detection target region 242 is a portion (hatched region in the example illustrated in FIG. 7) of a right half region of the region 241 (illustrated as a reference) relative to a forward moving direction of the vehicle 231, with the portion being separated from a front portion of the vehicle 231 by a predetermined distance (distance in a perpendicular direction) or greater.

The detection target region 242 is set, and thus, when there is an obstacle object in the detection target region 242, it is determined that there is an object which has to be avoided by the vehicle 231, and the driver of the vehicle 231 intentionally turns the vehicle 231 left (the vehicle 231 is turned right to return to its original direction after being turned left to avoid the object, or a steering operation for turning the vehicle 231 left).

The detection target region 212 when the vehicle 201 is turned right as illustrated in FIG. 6, and the detection target region 242 when the vehicle 231 is turned left as illustrated in FIG. 7 may be defined as various regions. In the examples, each of the lengths of L1, L11, L12 may have various values.

In the examples, since it is deemed that there can be an obstacle object in regions that extend rightwards and leftwards from the lateral width of the front portion of each of the vehicles 201 and 231, each of the detection target regions 212 and 242 includes these regions; however, as another configuration example, each of the detection target regions 212 and 242 may not include the regions which extend rightwards and leftwards from the lateral width of each of the front portions.

In the examples, when there is an obstacle object in the regions separated from the front portions of the vehicles 201 and 231 by less than a distance (distance in the perpendicular direction) of (L11+L12), the driver cannot avoid the obstacle object with ease, and it is deemed that the same collision avoidance assistance as in a normal case is preferably executed when the vehicles 201 and 231 move toward the obstacle object after the obstacle object is avoided. Therefore, each of the detection target regions 212 and 242 is set not to include these regions. As another configuration example, each of the detection target regions 212 and 242 may be set to include these regions.

In the examples, the detection target regions 212 and 242 are bilaterally symmetrical relative to right and left turn directions; however, as another configuration example, the detection target regions 212 and 242 may not be bilaterally symmetrical.

This determination may be performed based on other pieces of information.

One or more of the determinations may be performed by another processing unit (for example, the collision probability determination unit 22) other than the collision avoidance assistance unit 23, and determination result information may be input to and used by the collision avoidance assistance unit 23.

(Specific Technique for Example 3 of Condition)

As an example, with regard to the condition under which there is an intersection at the position of or in front of a vehicle (host vehicle), the collision avoidance assistance unit 23 determines whether or not there is a predetermined object based on object information input from the object detection unit 21, and when there is the predetermined object, the collision avoidance assistance unit 23 is capable of determining that there is the intersection. The predetermined object may be various objects, and can be a crossing vehicle in front of the vehicle (host vehicle), right turn or left turn of a proceeding vehicle (a proceeding vehicle which is about to turn right or left and a proceeding vehicle which has turned right or left), a traffic signal, a crosswalk, a roadside structure which is disposed such that two sides intersect each other, and the like.

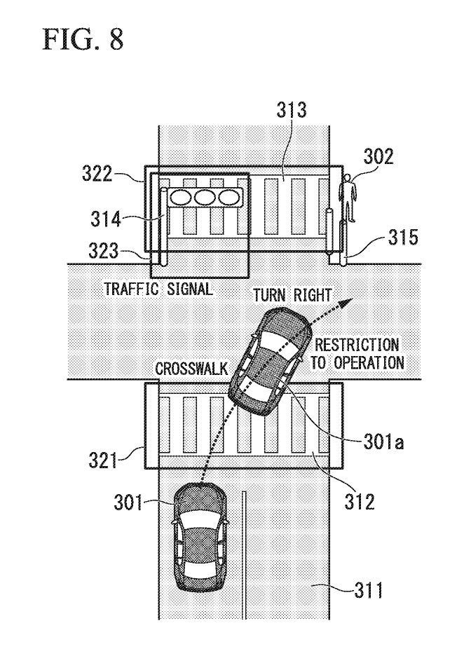

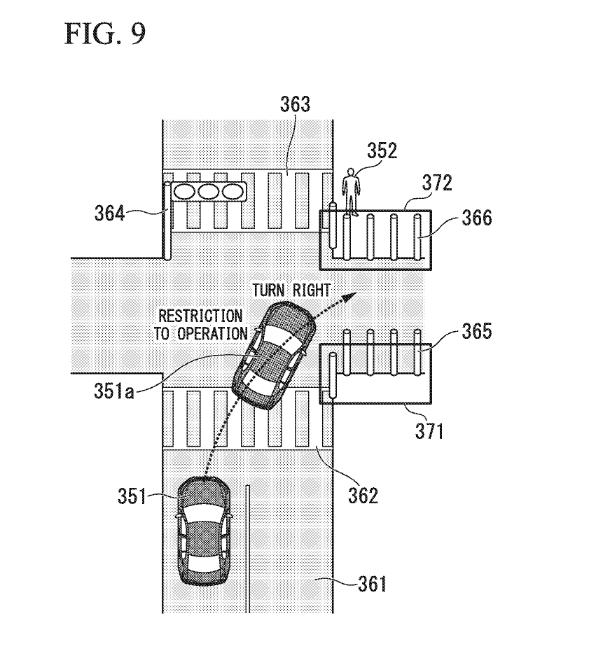

This determination will be described with reference to FIGS. 8 and 9.

FIG. 8 is a view illustrating an example of a technique of determining whether or not there is an intersection in the embodiment.

According to the technique in this example, it is detected whether or not there is an intersection at the position of or in front of a vehicle (host vehicle) 301 with the travel safety device 1.

The vehicle (host vehicle) 301 is traveling on a road 311. On the road 311, there is an intersection in front of the vehicle 301, a crosswalk 312 before the intersection, a crosswalk 313 after the intersection, and a traffic signal 314 in the vicinity of and slightly before the crosswalk 313. There is a roadside structure (for example, a pole) 315 on a road after the intersection, which is positioned on the right side relative to a forward moving direction of the vehicle 301. There is a person 302 who is a pedestrian in the vicinity of the roadside structure 315. FIG. 8 illustrates frames 321, 322, and 323 which respectively represent the image portions of the crosswalks 312 and 313 and the traffic signal 314 that are captured by the object detection unit 21 of the travel safety device 1 through image processing.

In this situation, the driver of the vehicle 301 turns the vehicle 301 right, and the vehicle 301 turns to the right. When the travel safety device 1 detects that there is an obstacle object (the roadside structure 315 or the person 302) in front of a vehicle 301a (the vehicle 301 which has moved), the travel safety device 1 operates the control of a brake or an alarm for the obstacle in front of the vehicle 301a. In this case, since the driver of the vehicle 301 intentionally turns the vehicle 301, when an operation is performed at a normal operation timing, the driver deems the operation as being excessive. For this reason, the collision avoidance assistance unit 23 of the travel safety device 1 executes timing adjustment for collision avoidance assistance so as to reduce a feeling of excessiveness.

In the example illustrated in FIG. 8, as an example, when the collision avoidance assistance unit 23 of the travel safety device 1 detects both (or, as another example, may be only an arbitrary one) of two crosswalks 312 and 313 before and after the intersection, the collision avoidance assistance unit 23 determines that there is an intersection.

As another example, when the collision avoidance assistance unit 23 of the travel safety device 1 detects the traffic signal 314, the collision avoidance assistance unit 23 determines that there is an intersection.

FIG. 9 is a view illustrating an example of a technique of determining whether or not there is an intersection in the embodiment.

According to the technique in this example, it is detected whether or not there is an intersection at the position of or in front of a vehicle (host vehicle) 351 with the travel safety device 1.

In the example illustrated in FIG. 9, a road 361 on which the vehicle (host vehicle) 351 with the travel safety device 1 is traveling, two crosswalks 362 and 363 before and after an intersection, a traffic signal 364, and a person 352 are situated in the same manner as the example illustrated in FIG. 8. The example illustrated in FIG. 9 is different from the example illustrated in FIG. 8 in that there are roadside structures (for example, poles) 365 and 366 at both ends of a road on the right side of the intersection. FIG. 9 illustrates frames 371 and 372 of the image portions of the roadside structures 365 and 366, respectively.

In the example illustrated in FIG. 9, when the collision avoidance assistance unit 23 of the travel safety device 1 detects both (or, as another example, may be only an arbitrary one) of the roadside structures 365 and 366 at both ends of the road on the right side of the intersection, the collision avoidance assistance unit 23 determines that there is an intersection (in this example, an intersection having a road on the right side thereof).

As another configuration example, when the collision avoidance assistance unit 23 of the travel safety device 1 detects that there is a standby vehicle (for example, a vehicle waiting to turn right or a vehicle waiting to turn left) on one or both of the roads on the left and right sides of the intersection, the travel safety device 1 may determine that there is an intersection.

Examples of the intersection include a crossroads and a T junction. In the example illustrated in FIG. 8 or the example illustrated in FIG. 9, both or only an arbitrary one of a crossroads and a T junction may be detected as an intersection to determine whether or not the condition is satisfied.

The roadside structure may be various objects such as a pole and a guardrail.

This determination may be performed based on other pieces of information.

As another example, with regard to the condition under which there is an intersection at the position of or in front of a vehicle (host vehicle), the collision avoidance assistance unit 23 determines whether or not the face or the eyes (the sight) of the driver in an image move either to the right or to the left relative to the forward moving direction at a predetermined angle or greater based on image information input from the image processing unit 52 of the vehicle interior sensor 13. When it is determined that the face or the eyes move as described above, the collision avoidance assistance unit 23 is capable of (presumptively) determining that there is an intersection.

One or more of the aforementioned determinations may be performed by another processing unit (for example, the collision probability determination unit 22) other than the collision avoidance assistance unit 23, and determination result information may be input to and used by the collision avoidance assistance unit 23.

(Specific Technique for Example 4 of Condition)

As an example, with regard to the condition under which a predetermined object (for example, objects other than a person) is deemed as an obstacle object to a vehicle (host vehicle), the collision avoidance assistance unit 23 is capable of determining whether or not the predetermined object is deemed as an obstacle object to the vehicle based on object information input from the object detection unit 21. In this case, information regarding a template image or the characteristic of the predetermined object is stored in a memory in advance, and the collision avoidance assistance unit 23 determines whether or not the information regarding the predetermined object matches information regarding an object deemed as an obstacle to the vehicle.

This determination may be performed based on other pieces of information.

This determination may be performed by another processing unit (for example, the collision probability determination unit 22) other than the collision avoidance assistance unit 23, and determination result information may be input to and used by the collision avoidance assistance unit 23.

(Specific Technique for Example 5 of Condition)

As an example, with regard to the condition under which timing adjustment for collision avoidance assistance is executed due to a driver's instruction, the collision avoidance assistance unit 23 is capable of determining whether or not a predetermined switch, predetermined content set or the like operated or set by a driver instructs the execution of timing adjustment for collision avoidance assistance.

This determination may be performed by another processing unit (for example, the collision probability determination unit 22) other than the collision avoidance assistance unit 23, and determination result information may be input to and used by the collision avoidance assistance unit 23.

<Specific Example of Timing Adjustment for Collision Avoidance Assistance in Response to Obstacle in Steering Direction in Embodiment>

When it is determined that a predetermined condition or two or more predetermined conditions are satisfied, the collision avoidance assistance unit 23, as adjusting a timing for collision avoidance assistance in response to an obstacle in a steering direction, executes one or both of the delay of the operation timing of automatic braking (the application of brakes) or an alarm and the advancing of a release timing after the operation has started, compared to other cases (for example, a normal case).

For example, the collision avoidance assistance unit 23 may be configured to execute the operation or the release of collision avoidance assistance at different timings for when a person is an object which may collide with a host vehicle and when objects other than a person may collide with the host vehicle. As a specific example, when a person (a weak person such as a pedestrian) is an object which may collide with the host vehicle, the collision avoidance assistance unit 23 executes one or both of the delaying of the operation timing of automatic braking (the application of brakes) or an alarm and the advancing of a release timing after the operation has started, compared to a normal case. The operation timing is advanced and the release timing is delayed compared to when objects other than a person may collide with the host vehicle. Accordingly, when a person is an object which may collide with the host vehicle, it is possible to mitigate the activation of the collision avoidance assistance compared to a normal case, and in contrast, it is possible to maintain (not to relatively reduce) the effects of the collision avoidance assistance compared to when objects other than a person may collide with the host vehicle.

As another configuration example, when a person is an object which may collide with the host vehicle, the collision avoidance assistance unit 23 may be configured to execute collision avoidance assistance at the same timing as a normal case.

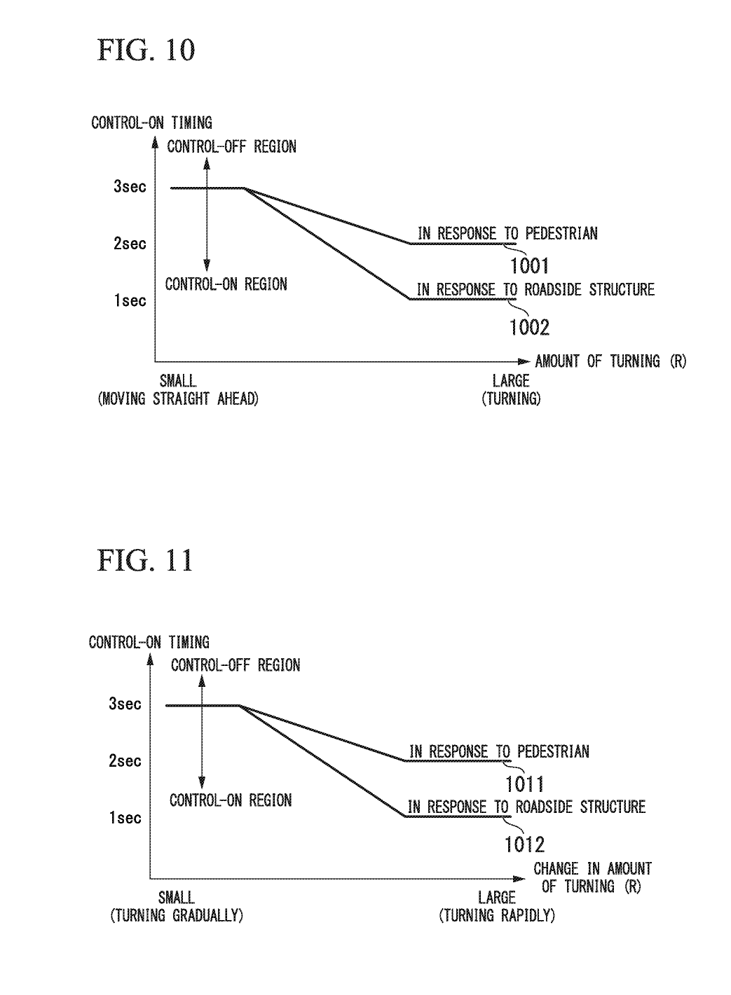

The specific examples of timing adjustment for collision avoidance assistance will be described with reference to FIGS. 10 to 14.

First, the specific examples will be described with reference to FIGS. 10 and 11.

FIG. 10 is a graph illustrating an example of timing adjustment for collision avoidance assistance in the embodiment.

In this example, according to the graph illustrated in FIG. 10, the collision avoidance assistance unit 23 controls the operation timing of collision avoidance assistance (for example, the operation of automatic braking (the application of brakes) or an alarm) or controls a release timing after the operation has started.

In the graph illustrated in FIG. 10, the horizontal axis represents the amount of turning (R), and the vertical axis represents the operation timing and the release timing of collision avoidance assistance.

The amount of turning (R) on the horizontal axis is, for example, a value proportional to the angle of steering. The movement of a vehicle is made close to a straight-ahead movement to the extent that the amount of turning (R) is small, and a vehicle turns through a large angle to the extent that the amount of turning (R) is large. The amount of turning (R) can be defined as the maximum amount of turning within a predetermined time.

In the example illustrated in FIG. 10, the vertical axis represents an amount of time (the estimated amount of time) taken for a host vehicle to collide with an object, that is, illustrates that an operation is quickly performed (the release of the operation is delayed) to the extent that a value (seconds) is large.

In the example illustrated in FIG. 10, according to a characteristic 1001 corresponding to a case in which an obstacle object is a person (for example, a pedestrian), the amount of timing adjustment for the operation and the release of collision avoidance assistance is restricted (is reduced) compared to a characteristic 1002 corresponding to a case in which an obstacle object is another object (for example, a roadside structure) other than a person. In the example illustrated in FIG. 10, in a region below the lines of the characteristics 1001 and 1002, the collision avoidance assistance unit 23 performs control such that the operation of collision avoidance assistance is turned on, and in a region above the lines of the characteristics 1001 and 1002, the collision avoidance assistance unit 23 performs control such that the operation of collision avoidance assistance is turned off (is released).

FIG. 11 is a graph illustrating another example of timing adjustment for collision avoidance assistance in the embodiment

In this example, according to the graph illustrated in FIG. 11, the collision avoidance assistance unit 23 controls the operation timing of collision avoidance assistance (for example, the operation of automatic braking (the application of brakes) or an alarm) or controls a release timing after the operation has started.

The example illustrated in FIG. 11 is different from the example illustrated in FIG. 10 in that the horizontal axis represents a change in the amount of turning (R). A vehicle turns gradually to the extent that a change in the amount of turning (R) is small, and the vehicle turns rapidly to the extent that a change in the amount of turning (R) is large.

Similar to the example illustrated in FIG. 10, FIG. 11 also illustrates a characteristic 1011 corresponding to a case in which an obstacle object is a person (for example, a pedestrian), and a characteristic 1012 corresponding to a case in which an obstacle object is another object (for example, a roadside structure) other than a person.

As another configuration example, in the example illustrated in FIG. 10 or the example illustrated in FIG. 11, the value on the horizontal axis can represent an amount of time required for turning (turning time period). A vehicle turns gradually to the extent that the turning time period is long, and the vehicle turns rapidly to the extent that the turning time period is short.

In the example illustrated in FIG. 10 or the example illustrated in FIG. 11, the value on the horizontal axis may represent information regarding steering torque, yaw, or acceleration (G) applied to the vehicle.

In the examples, the collision avoidance assistance unit 23 uses information regarding the characteristics 1001 and 1002 of the graph illustrated in FIG. 10, and information regarding the characteristics 1011 and 1012 of the graph illustrated in FIG. 11, which are stored in the memory.

In the examples, hystereses are not incorporated into the operation timing and the release timing of collision avoidance assistance; however, as another configuration example, hysteresis may be incorporated.

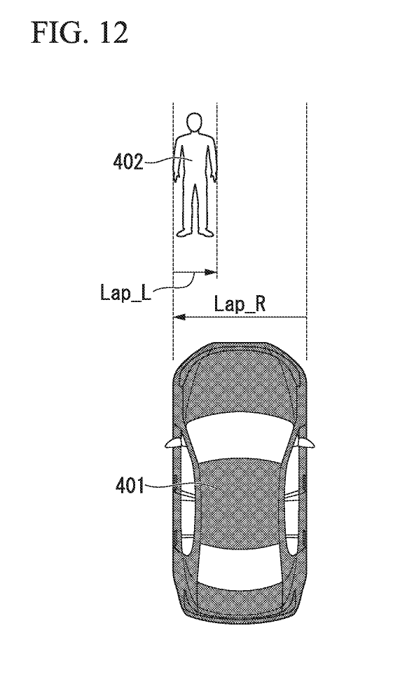

Hereinafter, a description will be given with reference to FIGS. 12 to 14.

FIG. 12 is a view illustrating the amount of overlap.

In the embodiment, the total amount of overlap Lap is defined as the smaller of the amount of overlap Lap_R between a right end point of a vehicle 401 and an obstacle 402 (in the example illustrated in FIG. 12, a pedestrian) and the amount of overlap Lap_L between a left end point of the vehicle 401 and the obstacle.

Specifically, the total amount of overlap Lap is adopted as the smaller of the amount of overlap Lap_R between the right end point of a vehicle 401 and an obstacle 402 and the amount of overlap Lap_L between the left end point of the vehicle 401 and the obstacle 402, that is, is min (Lap_L, Lap_R). In the example illustrated in FIG. 12, Lap_L is Lap.

The total amount of overlap Lap corresponds to the minimum extent of steering by which the vehicle 401 has to be turned to avoid the obstacle 402.

In the embodiment, the collision avoidance assistance unit 23 calculates the amount of overlap Lap based on object information input from the object detection unit 21.

This calculation may be performed by another processing unit (for example, the collision probability determination unit 22) other than the collision avoidance assistance unit 23, and result information may be notified to the collision avoidance assistance unit 23.

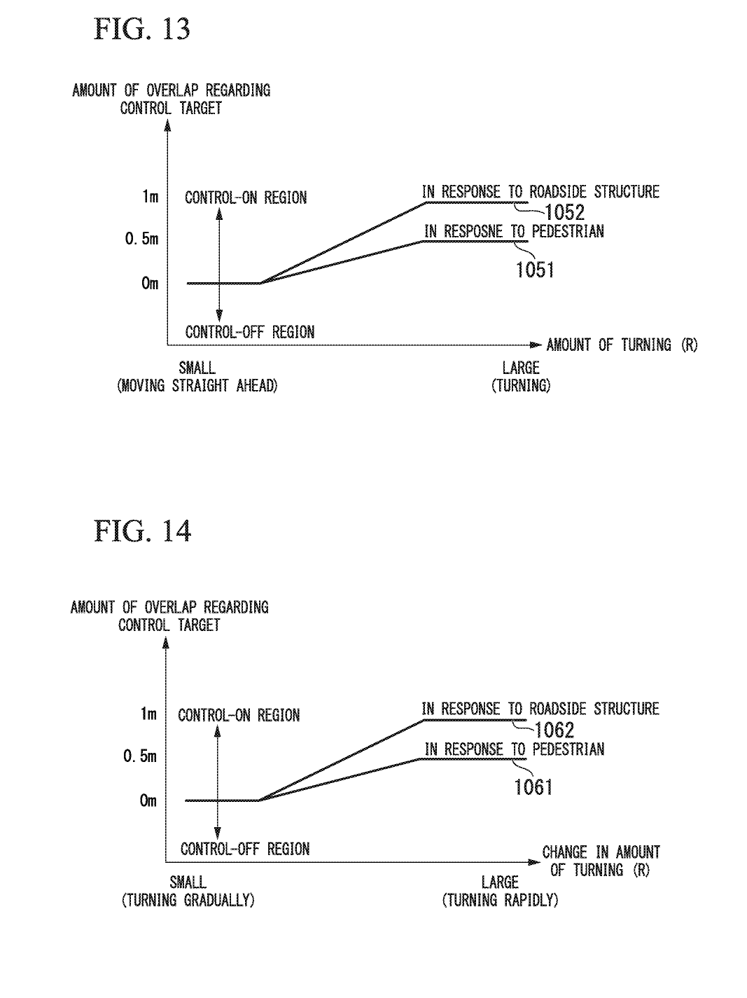

FIG. 13 is a graph illustrating an example of timing adjustment for collision avoidance assistance in the embodiment.

In this example, according to the graph illustrated in FIG. 13, the collision avoidance assistance unit 23 controls the operation timing of collision avoidance assistance (for example, the operation of automatic braking (the application of brakes) or an alarm) or controls a release timing after the operation has started.

In the graph illustrated in FIG. 13, the horizontal axis represents the amount of turning (R), and the vertical axis represents the operation timing and the release timing of collision avoidance assistance. The amount of turning (R) can be defined as the maximum amount of turning within a predetermined time.

In the example illustrated in FIG. 13, the vertical axis represents the amount of overlap between a vehicle and an obstacle object, that is, illustrates that an operation is quickly performed (the release of the operation is delayed) to the extent that a value (m) is small.

In the example illustrated in FIG. 13, according to a characteristic 1051 corresponding to a case in which an obstacle object is a person (for example, a pedestrian), the amount of operation timing adjustment and release timing adjustment for collision avoidance assistance is restricted (is reduced) compared to a characteristic 1052 corresponding to a case in which an obstacle object is another object (for example, a roadside structure) other than a person. In the example illustrated in FIG. 13, in a region above the lines of the characteristics 1051 and 1052, the collision avoidance assistance unit 23 performs control such that the operation of collision avoidance assistance is turned on, and in a region below the lines of the characteristics 1051 and 1052, the collision avoidance assistance unit 23 performs control such that the operation of collision avoidance assistance is turned off (is released).

FIG. 14 is a graph illustrating another example of timing adjustment for collision avoidance assistance in the embodiment

In this example, according to the graph illustrated in FIG. 14, the collision avoidance assistance unit 23 controls the operation timing of collision avoidance assistance (for example, the operation of automatic braking (the application of brakes) or an alarm) or controls a release timing after the operation has started.

The example illustrated in FIG. 14 is different from the example illustrated in FIG. 13 in that the horizontal axis represents a change in the amount of turning (R).

Similar to the example illustrated in FIG. 13, FIG. 14 also illustrates a characteristic 1061 corresponding to a case in which an obstacle object is a person (for example, a pedestrian), and a characteristic 1062 corresponding to a case in which an obstacle object is another object (for example, a roadside structure) other than a person.

As another configuration example, in the example illustrated in FIG. 13 or the example illustrated in FIG. 14, the value on the horizontal axis can represent an amount of time required for turning (turning time period).

In the example illustrated in FIG. 13 or the example illustrated in FIG. 14, the value on the horizontal axis may represent information regarding steering torque, yaw, or acceleration (G) applied to the vehicle.

In the examples, the collision avoidance assistance unit 23 uses information regarding the characteristics 1051 and 1052 of the graph illustrated in FIG. 13, and information regarding the characteristics 1061 and 1062 of the graph illustrated in FIG. 14, which are stored in the memory.

In the examples, hystereses are not incorporated into the operation timing and the release timing of collision avoidance assistance; however, as another configuration example, hysteresis may be incorporated.

As another configuration example, the collision avoidance assistance unit 23 can be configured to execute the operation or the release of collision avoidance assistance at different timings for when there is an intersection at the position of or in front of a vehicle and when there is no intersection at the position of or in front of the vehicle. As a specific example, when the conditions for executing timing adjustment for collision avoidance assistance are satisfied except for whether or not there is an intersection, and there is no intersection at the position of or in front of a vehicle, the collision avoidance assistance unit 23 executes one or both of the delaying of the operation timing of automatic braking (the application of brakes) or an alarm and the advancing of a release timing after the operation has started, compared to a normal case. The operation timing is advanced and the release timing is delayed compared to when the conditions for executing timing adjustment for collision avoidance assistance are satisfied except for whether or not there is an intersection, and there is an intersection at the position of or in front of a vehicle. Accordingly, when the conditions for executing timing adjustment for collision avoidance assistance are satisfied except for whether or not there is an intersection, and there is no intersection at the position of or in front of a vehicle, it is possible to mitigate the activation of the collision avoidance assistance compared to a normal case, and in contrast, it is possible to maintain (not to relatively reduce) the effects of the collision avoidance assistance compared to when there is an intersection at the position of or in front of the vehicle.

As another configuration example, when there is no intersection at the position of or in front of a vehicle, the collision avoidance assistance unit 23 may be configured to execute collision avoidance assistance at the same timing as a normal case.

In the aforementioned configurations, the operation timing and the release timing of collision avoidance assistance are controlled based on the common characteristics (for example, the characteristics of the same graph); however, as another configuration example, the operation timing and the release timing of collision avoidance assistance may be controlled based on different characteristics (for example, the characteristics of different graphs).

For example, both of the operation timing and the release timing of collision avoidance assistance may be controlled, or only an arbitrary one may be controlled.

As another configuration example, the amount of operation of collision avoidance assistance may be restricted to restrict the collision avoidance assistance. A technique of reducing the amount of operation for various operations related to collision avoidance assistance can be used as a technique of restricting (mitigating) collision avoidance assistance. As a specific example, it is possible to reduce the output of a brake operation for collision avoidance assistance, or to reduce the volume of an alarm for collision avoidance assistance.

### First Embodiment

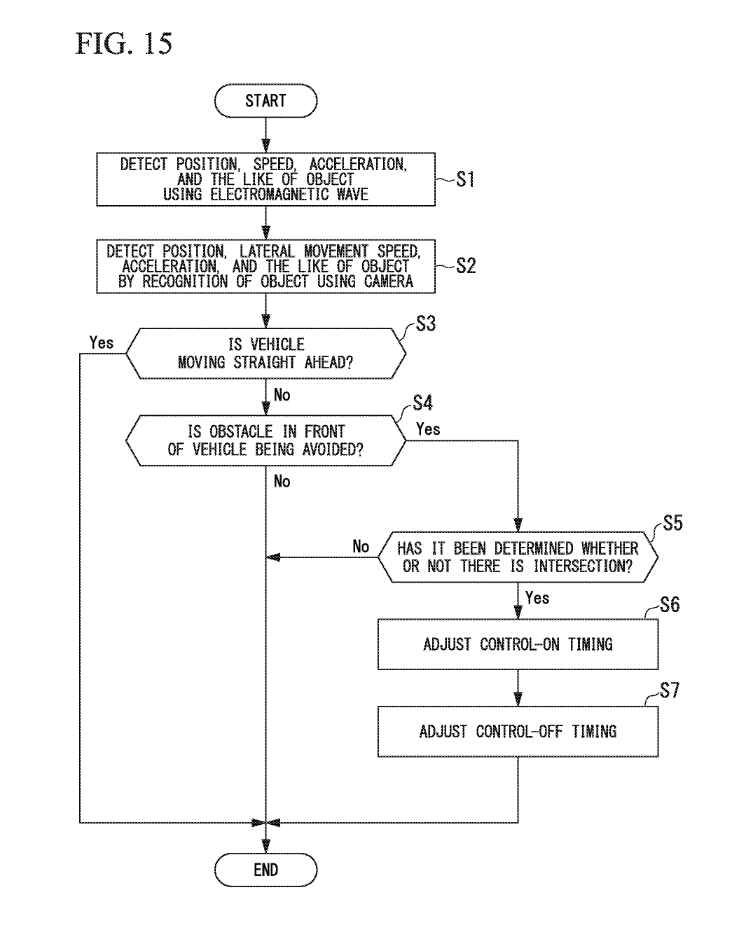

FIG. 15 is a flowchart illustrating an example of the flow of timing adjustment for collision avoidance assistance in a first embodiment of the present invention.

The travel safety device 1 of a vehicle (host vehicle) performs the following processes.

The object detection unit 21 detects information regarding the position, the speed, the acceleration, and the like of an object in an external field, using an electromagnetic wave emitted from the radar unit 41 of the external field sensor 12 (step S1).

The object detection unit 21 detects information regarding the position, the movement speed (for example, the lateral movement speed relative to a forward moving direction of the vehicle), the acceleration (for example, the lateral acceleration relative to the forward moving direction of the vehicle), and the like of the object in the external field, based on an image captured by the camera 31 of the external field sensor 12 (step S2).

The collision avoidance assistance unit 23 determines whether or not the vehicle is moving straight ahead, based on one or more pieces of information of the object information input from the object detection unit 21, image information input from the image processing unit 52 of the vehicle interior sensor 13, and vehicle status information input from the vehicle status detection unit 14 (step S3).

When as a result of the determination in step S3, it is determined that the vehicle is moving straight ahead, the collision avoidance assistance unit 23 ends the process (the process of timing adjustment for collision avoidance assistance) without execution.

When as a result of the determination in step S3, it is determined that the vehicle is not moving straight ahead (for example, the vehicle is turning right or left), the collision avoidance assistance unit 23 determines whether the vehicle is avoiding an obstacle in front of the vehicle (which may include positions offset in rightward and leftward directions), based on one or more pieces of information of the object information input from the object detection unit 21 and the vehicle status information input from the vehicle status detection unit 14 (step S4).

When as a result of the determination in step S4, it is determined that the vehicle is not avoiding an obstacle in front of the vehicle (which may include positions offset in the rightward and leftward directions), the collision avoidance assistance unit 23 ends the process (the process of timing adjustment for collision avoidance assistance) without execution.

When as a result of the determination in step S4, it is determined that the vehicle is avoiding an obstacle in front of the vehicle (which may include positions offset in the rightward and leftward directions), the collision avoidance assistance unit 23 determines that there is an intersection at the position of or in front of the vehicle, based on one or more pieces of information of the object information input from the object detection unit 21 and the image information input from the image processing unit 52 of the vehicle interior sensor 13 (step S5).

When as a result of the determination in step S5, it is determined that there is no intersection at the position of or in front of the vehicle, the collision avoidance assistance unit 23 ends the process (the process of timing adjustment for collision avoidance assistance) without execution.

When as a result of the determination in step S5, it is determined that there is an intersection at the position of or in front of the vehicle, the collision avoidance assistance unit 23 executes timing adjustment for collision avoidance assistance. Specifically, when based on determination result information input from the collision probability determination unit 22, it is determined that the vehicle may collide with the object, the collision avoidance assistance unit 23 performs control such that the operation timing (control-on timing for collision avoidance assistance) of automatic braking (the application of brakes) or an alarm is delayed compared to a normal case (step S6), and performs control such that the release timing (control-off timing for collision avoidance assistance) of the operation after the operation has started is advanced compared to a normal case (step S7).

As described above, in the embodiment, when it is determined that all of the following conditions are satisfied: the condition under which the vehicle is moving straight ahead (the condition for step S3), the condition under which the vehicle is avoiding an obstacle in front of the vehicle (which may include positions offset in the rightward and leftward directions) (the condition for step S4), and the condition under which there is an intersection at the position of or in front of the vehicle (the condition for step S5), the collision avoidance assistance unit 23 executes operation timing adjustment and release timing adjustment for collision avoidance assistance.

### Second Embodiment

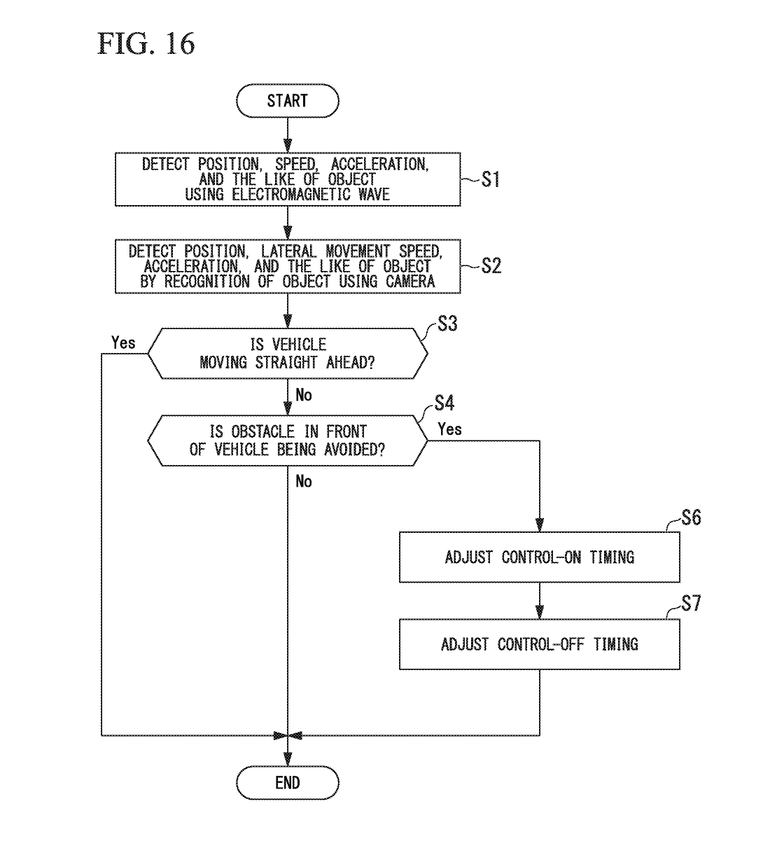

FIG. 16 is a flowchart illustrating an example of the flow of timing adjustment for collision avoidance assistance in a second embodiment of the present invention.

When the flow of timing adjustment for collision avoidance assistance in the embodiment is compared to that illustrated in FIG. 15, schematically, step S5 is removed from the flowchart in FIG. 15. In FIG. 16, the same reference signs are assigned to the same steps as those illustrated in FIG. 15.

The travel safety device 1 of a vehicle (host vehicle) performs the following processes.

That is, first, steps S1 to S4 are executed.

When as a result of the determination in step S4, it is determined that the vehicle is not avoiding an obstacle in front of the vehicle (which may include positions offset in rightward and leftward directions), the collision avoidance assistance unit 23 ends the process (the process of timing adjustment for collision avoidance assistance) without execution.

When as a result of the determination in step S4, it is determined that the vehicle is avoiding an obstacle in front of the vehicle (which may include positions offset in rightward and leftward directions), the collision avoidance assistance unit 23 executes timing adjustment for collision avoidance assistance. That is, steps S6 and S7 are executed.

As described above, in the embodiment, when it is determined that both of the following conditions are satisfied: the condition under which the vehicle is moving straight ahead (the condition for step S3) and the condition under which the vehicle is avoiding an obstacle in front of the vehicle (which may include positions offset in the rightward and leftward directions) (the condition for step S4), the collision avoidance assistance unit 23 executes operation timing adjustment and release timing adjustment for collision avoidance assistance.

### Third Embodiment

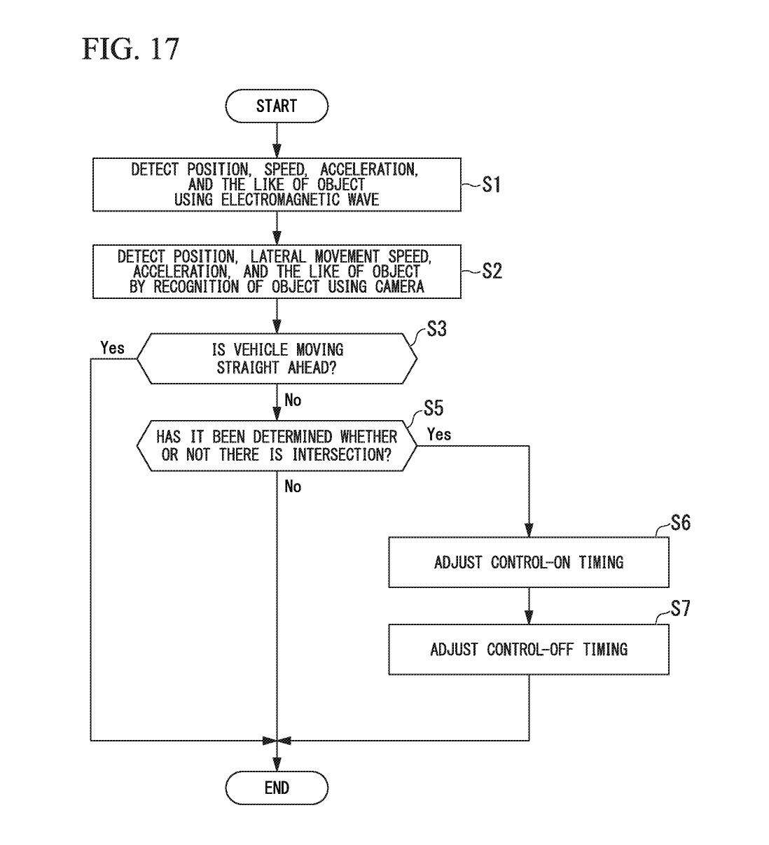

FIG. 17 is a flowchart illustrating an example of the flow of timing adjustment for collision avoidance assistance in a third embodiment of the present invention. When the flow of timing adjustment for collision avoidance assistance in the embodiment is compared to that illustrated in FIG. 15, schematically, step S4 is removed from the flowchart in FIG. 15. In FIG. 17, the same reference signs are assigned to the same steps as those illustrated in FIG. 15.

The travel safety device 1 of a vehicle (host vehicle) performs the following processes.

That is, first, steps S1 to S3 are executed.

When as a result of the determination in step S3, it is determined that the vehicle is moving straight ahead, the collision avoidance assistance unit 23 ends the process (the process of timing adjustment for collision avoidance assistance) without execution.

When as a result of the determination in step S3, it is determined that the vehicle is not moving straight ahead (for example, the vehicle is in the middle of turning right or left), the collision avoidance assistance unit 23 determines whether or not there is an intersection at the position of or in front of the vehicle, based on one or more pieces of information of object information input from the object detection unit 21 and image information input from the image processing unit 52 of the vehicle interior sensor 13 (step S5).

Step S5, and steps S6 and S7 subsequent thereto are executed.

As described above, in the embodiment, when it is determined that both of the following conditions are satisfied: the condition under which the vehicle is moving straight ahead (the condition for step S3) and the condition under which there is an intersection at the position of or in front of the vehicle (the condition for step S5), the collision avoidance assistance unit 23 executes operation timing adjustment and release timing adjustment for collision avoidance assistance.

### Fourth Embodiment

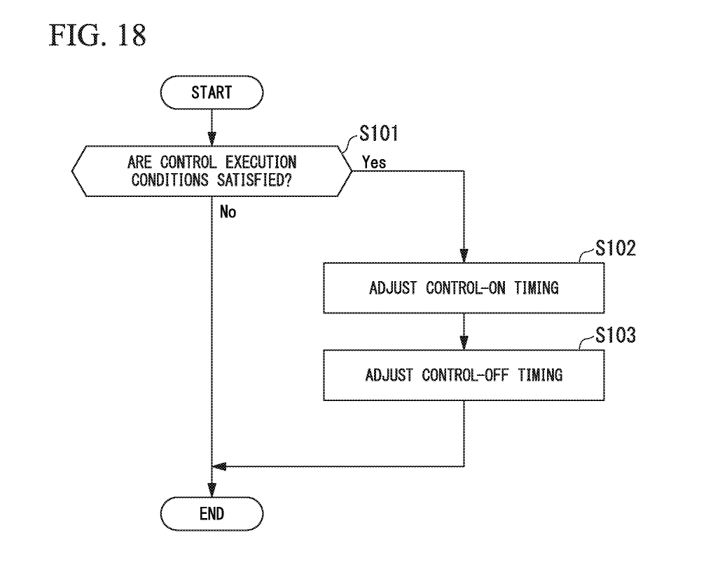

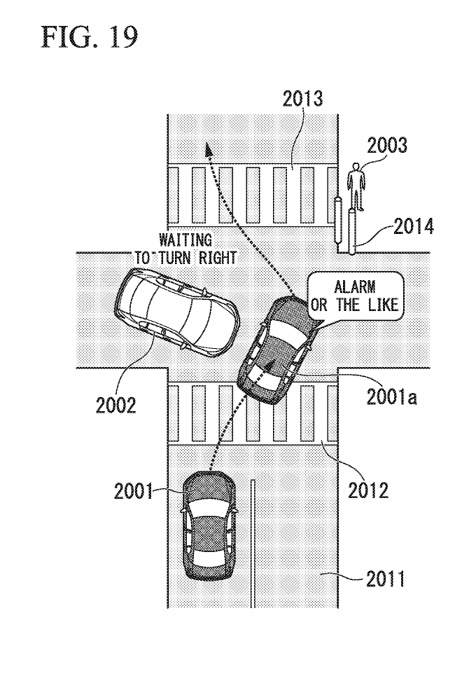

FIG. 18 is a flowchart illustrating an example of the flow of timing adjustment for collision avoidance assistance in a fourth embodiment of the present invention.

In the embodiment, one or more of various conditions may be used as the conditions for executing timing adjustment for collision avoidance assistance.

The travel safety device 1 of a vehicle (host vehicle) detects various pieces of information using the external field sensor 12, the vehicle interior sensor 13, the vehicle status detection unit 14, and the like, and the collision avoidance assistance unit 23 determines whether or not conditions (control execution conditions) for executing the control of timing adjustment for collision avoidance assistance are satisfied, based on all or parts of the pieces of information (step S101).

When as a result of the determination in step S101, it is determined that the control execution conditions are not satisfied, the collision avoidance assistance unit 23 ends the process (the process of timing adjustment for collision avoidance assistance) without execution.

When as a result of the determination in step S5, it is determined that the control execution conditions are satisfied, the collision avoidance assistance unit 23 executes timing adjustment for collision avoidance assistance. Specifically, when based on determination result information input from the collision probability determination unit 22, it is determined that the vehicle may collide with an object, the collision avoidance assistance unit 23 performs control such that the operation timing (control-on timing for collision avoidance assistance) of automatic braking (the application of brakes) or an alarm is delayed compared to a normal case (step S102), and performs control such that the release timing (control-off timing for collision avoidance assistance) of the operation after the operation has started is advanced compared to a normal case (step S103).

[Summary of Aforementioned Embodiment]

In an embodiment, in a travel safety device 1 including an external field sensor 12 and an object detection unit 21, or a vehicle interior sensor 13 which serve as object detection devices; a vehicle status detection unit 14 serving as a device that detects the status of a vehicle (host vehicle); a collision probability determination unit 22 serving as a device that determines whether or not the vehicle may collide with an object (solid object in front of the vehicle or the like) detected by the object detection devices; and a collision avoidance assistance unit 23 serving as a device that performs collision avoidance assistance when the collision probability determination unit 22 determines that the vehicle may collide with the object, the collision avoidance assistance unit 23 restricts the operation or the release of collision avoidance assistance according to the status of steering performed by a driver of the vehicle. As another configuration example, the collision avoidance assistance unit 23 may restrict the amount of operation of collision avoidance assistance.

Accordingly, it is possible to restrict excessive collision avoidance assistance when the driver intentionally makes a steering input.

In the embodiment, in the travel safety device 1, the collision avoidance assistance unit 23 restricts the operation or the release of collision avoidance assistance when there is an object in a direction of steering input depending on the status of steering performed by the driver of the vehicle (host vehicle).

Accordingly, it is possible to restrict excessive collision avoidance assistance when the driver intentionally makes a steering input, and there is the object in the direction of steering input.

In the embodiment, in the travel safety device 1, the collision avoidance assistance unit 23 restricts the operation or the release of collision avoidance assistance when the driver intentionally makes a steering input in a state where an object is detected in front of the vehicle (host vehicle) (which may include positions offset in rightward and leftward directions).

Accordingly, when the driver avoids the object in front of the vehicle (which may include positions offset in the rightward and leftward directions), the operation or the release of collision avoidance assistance is restricted, it is possible to accurately recognize the steering operation as a driver's intention, and to restrict excessive collision avoidance assistance.

For example, the object in front of the vehicle (host vehicle) may include an object that is not on a forward-moving track and is outside of, but is close to the host vehicle in a lateral direction of the host vehicle, that is, an object which is positioned so that the driver can typically avoid the object.

In the embodiment, in the travel safety device 1, the collision avoidance assistance unit 23 determines whether an object in the direction of steering input is a person (for example, a pedestrian) or another object (for example, a roadside structure) other than a person, and when it is determined that the object is a person, the collision avoidance assistance unit 23 reduces the amount of restriction to collision avoidance assistance compared to when it is determined that the object is the object other than a person.

Accordingly, it is possible to restrict excessive collision avoidance assistance such that the person (for example, a pedestrian) is prevented from being frightened.

In the embodiment, in the travel safety device 1, the collision avoidance assistance unit 23 reduces the amount of restriction to collision avoidance assistance to the extent that an amount (the amount of overlap) by which the vehicle (host vehicle) overlaps an object in the direction of steering input is large.

It is possible to change the amount of restriction to collision avoidance assistance according to the amount of overlap between the object in the direction of steering input and the vehicle (host vehicle), and thus, it is possible to appropriately execute collision avoidance assistance while restricting excessive collision avoidance assistance.

In the embodiment, in the travel safety device 1, the collision avoidance assistance unit 23 restricts the operation or the release of collision avoidance assistance when the driver of the vehicle (host vehicle) intentionally makes a steering input in a state where it is determined that there is an intersection.

Accordingly, it is possible to recognize that the tip of a crossing vehicle passes over a lane (lane of the vehicle) at the intersection, or that the driver intends to turn the vehicle (host vehicle) right or left, and to restrict excessive collision avoidance assistance.

In the embodiment, in the travel safety device 1, when the collision avoidance assistance unit 23 detects any one of a crossing vehicle in front of the vehicle (host vehicle), right turn or left turn of a proceeding vehicle, a traffic signal, a crosswalk, and a roadside structure which is disposed such that two sides intersect each other, the collision avoidance assistance unit 23 determines that there is an intersection.

Accordingly, it is possible to accurately recognize the intersection.

It is possible to execute a method (for example, a vehicle travel safety method) of the process performed by the device (for example, the vehicle travel safety device 1) in the aforementioned embodiment.

A program (for example, a vehicle travel safety program) for realizing parts or all of the functions of the device (for example, the vehicle travel safety device 1) in the aforementioned embodiment may be recorded in a computer-readable recording medium, and the program recorded in the recording medium may be read onto and executed by a computer system such that the process is performed.

The “computer system” referred to here may include an operating system (OS) or hardware of peripheral equipment and the like.

The “computer-readable recording medium” represents writable non-volatile memories such as a flexible disk, a magneto-optical disk, a read only memory (ROM), and a flash memory; a portable medium such as a digital versatile disk (DVD), and a storage device such as a hard disk built into a computer system.

Examples of the “computer-readable recording medium” also includes a recording medium configured to hold a program for a certain amount of time such as a non-volatile memory (for example, a dynamic random access memory (DRAM)) inside a computer system that serves as a server or a client when a program is transmitted via a network (for example, Internet) or a communication channel (telephone line).

The program may be transmitted, via a transmission medium or a transmission wave in the transmission medium, to another computer system from a computer system that stores the program in a storage device or the like. The “transmission medium”, which transmits the program, represents a medium that has a function of transmitting information via a network (for example, Internet) or communication channel (communication line) (for example, telephone line).

The program may realize parts of the functions. In addition, the program may be a so-called difference file (difference program) in which the functions can be realized in combination with the program that has already recorded in the computer system.

The preferred embodiments of the present invention have been described and exemplified. The embodiments are merely the illustration of the invention, and do not have to limit the present invention. Additions, deletions, replacements, and other modifications can be made to the present invention insofar as the additions, the deletions, the replacements, and the other modifications do not depart from the scope of the present invention. That is, the present invention is not limited to the embodiments, and is limited by the claims disclosed herein.

### INDUSTRIAL APPLICABILITY

The present invention relates to a vehicle travel safety device, and is capable of restricting excessive collision avoidance assistance.

### REFERENCE SIGNS LIST

1: VEHICLE TRAVEL SAFETY DEVICE
11: PROCESSING DEVICE
12: EXTERNAL FIELD SENSOR (OBJECT INFORMATION DETECTION UNIT)
13: VEHICLE INTERIOR SENSOR (OBJECT INFORMATION DETECTION UNIT)
14: VEHICLE STATUS DETECTION UNIT (VEHICLE STATUS INFORMATION DETECTION UNIT)
15: OPERATION CONTROL UNIT
16: ALARM UNIT
21: OBJECT DETECTION UNIT (OBJECT INFORMATION DETECTION UNIT)
22: COLLISION PROBABILITY DETERMINATION UNIT
23: COLLISION AVOIDANCE ASSISTANCE UNIT
31, 51: CAMERA
32, 52: IMAGE PROCESSING UNIT
41: RADAR UNIT
42: RADAR CONTROL UNIT
101, 101a, 102, 121, 121a, 122, 141, 141a, 142, 161, 161a, 162, 201, 231, 301, 301a, 351, 351a, 401, 2001, 2001a, 2002: VEHICLE
103, 123, 143, 163, 302, 2003: PERSON
111, 131, 151, 171, 311, 361, 2011: ROAD
112, 132, 152, 172, 315, 365, 366, 2014: ROADSIDE STRUCTURE
115, 135, 155, 175, 321 TO 323, 371, 372: FRAME
211, 241: REGION
212, 242: DETECTION TARGET REGION
312, 313, 362, 363, 2012, 2013: CROSSWALK
314, 364: TRAFFIC SIGNAL
402: OBSTACLE
1001, 1002, 1011, 1012, 1051, 1052, 1061, 1062: CHARACTERISTIC

1. A vehicle travel safety device comprising:
an object information detection unit that detects information regarding an object;
a vehicle status information detection unit that detects information regarding the status of a vehicle;
a collision probability determination unit that determines whether or not the vehicle may collide with the object, regarding which information is detected by the object information detection unit; and
a collision avoidance assistance unit that performs collision avoidance assistance when the collision probability determination unit determines that the vehicle may collide with the object, and restricts collision avoidance assistance according to the status of steering performed by a driver of the vehicle,
wherein when the driver of the vehicle turns the vehicle in a state where an object is detected in front of the vehicle, the collision avoidance assistance unit restricts collision avoidance assistance in response to an object different from the object in front of the vehicle.

2. The vehicle travel safety device according to claim 1,
wherein the collision avoidance assistance unit restricts collision avoidance assistance when there is an object in a steering direction depending on the status of steering performed by the driver of the vehicle.

3. (canceled)

4. The vehicle travel safety device according to claim 1,
wherein the collision avoidance assistance unit determines whether an object in a steering direction is a person or an object other than a person, and when it is determined that the object is a person, the collision avoidance assistance unit reduces the amount of restriction to collision avoidance assistance compared to when it is determined that the object is the object other than a person.

5. The vehicle travel safety device according to claim 1,
wherein the collision avoidance assistance unit reduces the amount of restriction to collision avoidance assistance to the extent that the amount of overlap between an object in the steering direction and the vehicle is large.

6. The vehicle travel safety device according to claim 1,
wherein the collision avoidance assistance unit restricts collision avoidance assistance when the driver turns the vehicle in a state where it is determined that there is an intersection.

7. The vehicle travel safety device according to claim 6,
wherein when the collision avoidance assistance unit detects any one of a crossing vehicle in front of the vehicle, right turn or left turn of a proceeding vehicle, a traffic signal, a crosswalk, and a roadside structure which is disposed such that two sides intersect each other, the collision avoidance assistance unit determines that there is an intersection.

8. A vehicle travel safety method comprising:
detecting information regarding an object using an object information detection unit;
detecting information regarding the status of a vehicle using a vehicle status information detection unit;
determining whether or not the vehicle may collide with the object, regarding which information is detected by the object information detection unit, using a collision probability determination unit; and
performing collision avoidance assistance when the collision probability determination unit determines that the vehicle may collide with the object, and restricting collision avoidance assistance according to the status of steering performed by a driver of the vehicle, using a collision avoidance assistance unit,
wherein when the driver of the vehicle turns the vehicle in a state where an object is detected in front of the vehicle, the collision avoidance assistance unit restricts collision avoidance assistance in response to an object different from the object in front of the vehicle.

9. A vehicle travel safety program causing a computer to execute:
a step of detecting information regarding an object using an object information detection unit;
a step of detecting information regarding the status of a vehicle using a vehicle status information detection unit;
a step of determining whether or not the vehicle may collide with the object, regarding which information is detected by the object information detection unit, using a collision probability determination unit; and
a step of performing collision avoidance assistance when the collision probability determination unit determines that the vehicle may collide with the object, and restricting collision avoidance assistance according to the status of steering performed by a driver of the vehicle, using a collision avoidance assistance unit,
wherein when the driver of the vehicle turns the vehicle in a state where an object is detected in front of the vehicle, the collision avoidance assistance unit restricts collision avoidance assistance in response to an object different from the object in front of the vehicle.
